(19) United States
(12) Patent Application Publication
(10) Pub. No.: US 2015/0317313 A1
(43) Pub. Date: Nov. 5, 2015

(54) SEARCHING LOCALLY DEFINED ENTITIES

(71) Applicant: Microsoft Corporation, Redmond, WA (US)

(72) Inventors: Yuanhua Lv, Sunnyvale, CA (US); Ariel Fuxman, San Francisco, CA (US); Ashok Chandra, Saratoga, CA (US); Zhaohui Wu, State College, PA (US)

(73) Assignee: Microsoft Corporation, Redmond, WA (US)

(21) Appl. No.: 14/268,953

(22) Filed: May 2, 2014

(51) Int. Cl. G06F 17/30

(52) U.S. Cl. CPC G06F 17/3053; G06F 17/30864

(57) ABSTRACT

A user can select a name of an entity such as a character in a book. In response to the selection, the passages of the book are processed using entity frequency and passage length to determine passages that are relevant to the entity. These relevant passages are processed to determine which of the relevant passages are descriptive and are most likely to help a user understand the entity by identifying characteristics of helpful passages such as words that indicate particular actions, words that are associated with biographical information, or the location of the passage in the book. The most descriptive passages can be shown to the user on the computing device that he is using to view the book.

### BACKGROUND

When consuming content in a document, users typically encounter entities that they are not familiar with. Where the document is a book, the entity may include a character or place in the book or a historical figure, for example. Where the document is a report or study, the entity may include names of people in an organization or internal project names or codes, for example.

If the entity or document is popular, the user may learn about the entity using an external source such as the Internet or through a search engine. However, if the entity is not very popular, often little information about the entity is available outside of the document itself. Such entities are referred to herein as locally defined entities. For example, a user may read a novel on an e-reader and may come across the name of a character. The user may not remember who the character is. If the character is minor (e.g., “Mary Jane” in Huckleberry Finn), there may be no information available about the character available on the Internet. However, somewhere in the novel is information that may give the user an understanding of the character.

In another example, a user may be reading a report in an enterprise environment and may come across the name of a project. If the project is new, there may be little information about the project on the company intranet, let alone on the Internet. However, similar to the novel example, the report itself may include introductory information about the project that may help the user understand the project.

Current solutions to finding more information about locally defined entities in the document itself include performing a text search of the name of the locally defined entity within the document (e.g., “control-f”). However, there are several drawbacks associated with such a search. First, text searches merely find all occurrences of the locally defined entity name in the document, but are not able to determine which of the many occurrences are most likely to help the user understand the locally defined entity.

Second, text searches may be over-inclusive and may match words in the document that are the same as the entity name, but do not actually refer to the document. For example, a search for the character “Mary” may match a character with the name “Mary Anne” even though they are different.

Third, text searches may be under-inclusive and may not match words in the document that are different than the entity name, but in fact do refer to the same entity. For example, a search for a character named “Michael” may not match occurrences of the name “Mike” even though these names refer to the same character. In addition, the text searches may not match an entity name against pronouns such as he, she, it, they, etc. even when they are referring to the entity name that is being searched for.

### SUMMARY

A user can select, query for, or input a name of a locally defined entity such as a character in a book. In response to the action, the passages of the book are processed using entity frequency and passage length to determine passages that are relevant to the locally defined entity. These relevant passages are processed to determine which of the relevant passages are descriptive and are most likely to help a user understand the locally defined entity by identifying characteristics of helpful passages such as words that indicate particular actions, words that are associated with biographical information, or the location of the passage in the book. The most descriptive passages can be shown to the user on the computing device that he is using to view the book.

In an implementation, a query for a document is received by a computing device. The query may identify an entity, and the document may include passages. Relevant passages of the document are determined by the computing device. Each relevant passage is relevant to the identified entity. A descriptiveness score for each relevant passage is determined with respect to the identified entity by the computing device. The relevant passages are presented according to the determined descriptiveness score by the computing device.

In an implementation, an identifier of a document is received by a computing device. The document includes passages. Identifiers of entities are received by the computing device. For each identified entity: relevant passages of the document are determined by the computing device, a descriptiveness score is determined for each relevant passage by the computing device, and references to one or more of the relevant passages are added to an entry associated with the identified entity in an index according to the determined descriptiveness score by the computing device. The index is associated with the identified document by the computing device.

This summary is provided to introduce a selection of concepts in a simplified form that are further described below in the detailed description. This summary is not intended to identify key or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 shows an environment for identifying and ranking relevant passages in a document based on an identified entity;

FIG. 2 is an illustration of an example user interface;

FIG. 3 is an illustration of an example passage identifier;

FIG. 4 is an operational flow of an implementation of a method for determining and presenting descriptive passages;

FIG. 5 is an operational flow of an implementation of a method for generating an index for a document;

FIG. 6 is an operational flow of an implementation of a method for determining relevant passages for an entity; and

FIG. 7 shows an exemplary computing environment.

### DETAILED DESCRIPTION

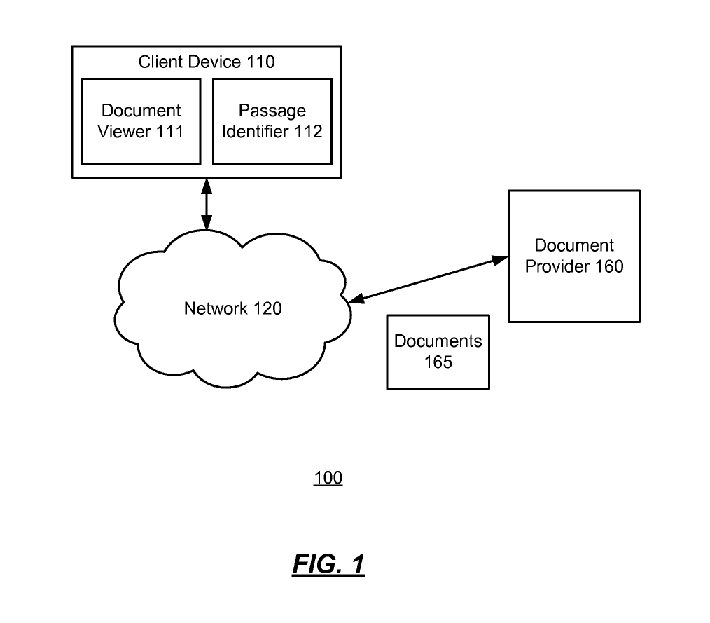

FIG. 1 shows an environment 100 for identifying and ranking relevant passages in a document based on an identified entity. The environment 100 includes a client device 110 that retrieves one or more documents 165 from a document provider 160 through a network 120. The client device 110 may include a desktop personal computer, workstation, laptop, personal digital assistant (PDA), electronic reading device (e-reader), smartphone, cell phone, or any WAP-enabled device or any other computing device. The network 120 may be a variety of network types including the public switched telephone network (PSTN), a cellular telephone network, a local intranet, and a packet switched network (e.g., the Internet).

The documents 165 may include a variety of documents and may include any type of document that includes at least some text. Examples of suitable documents 165 include e-books, reports, web pages, transcripts, word processor files, image files such as gifs and jpegs, and presentations, for example. Other types of files may be supported.

Depending on the implementation, a document 165 may be a single document 165 such as a single e-book or word processing document. Alternatively or additionally, a document 165 may comprise a series or group of documents 165. For example, a trilogy of novels, a series of related reports, and one or more linked or associated web pages may each be considered a document 165.

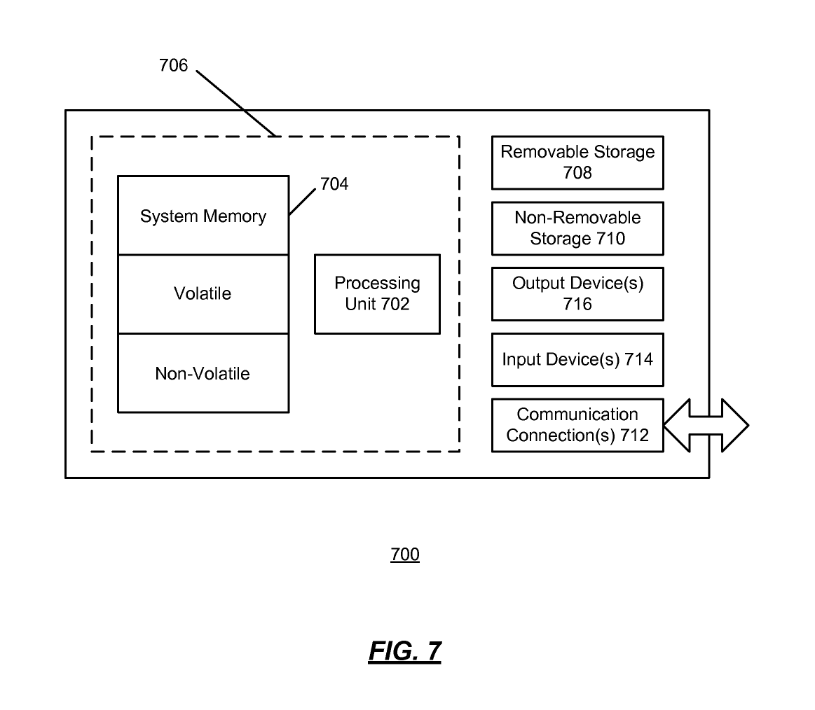

The document provider 160 may include any entity or service that is capable of providing and/or storing documents 165. Examples of document providers include an e-book service, a web server, and a local storage device where documents 165 are made available to local or remote users of an intranet. Although one document provider 160 and one client device 110 are shown, it is for illustrative purposes only; there is no limit to the number of document providers 160 and client devices 110 that may be supported in the environment 100. The document provider 160 and the client device 110 may be implemented together or separately using one or more computing devices such as the computing device 700 illustrated with respect to FIG. 7.

The client device 110 may include a document viewer 111 that may allow a user associated with the client device 110 to use and view documents 165. The document viewer 111 may be a variety of software applications such as an e-reader application, word processing application, text editor, web browser, image viewer, or any other application capable of displaying text.

A document 165 may include one or more passages. A passage may comprise a group of words or strings. Each word may have a corresponding type such as noun, adjective, verb, adverb, etc. Depending on the implementation, passages may include sentences, paragraphs, or chapters, for example.

Each passage of a document may include one or more entities. An entity as used herein refers to any named person, place, thing, activity, action, etc. that may appear in a document 165. Examples of entities may include: the names of characters, events, and locations in a novel; the names of historical figures, places, wars, and other historical events in a non-fiction book; and the names of individuals, products, and initiatives associated with an organization or company in a report. Entities may include words and phrases and may have types such as nouns, verbs, adverbs, and adjectives, for example.

The entities may also include what are referred to herein as locally defined entities. A locally defined entity may be any entity, such as those described above for example, that appears in a particular document or set of document, and/or any entity about which there is little information available outside the particular document or set of documents. Examples of locally defined entities may be a character in a novel or the internal name of a project. The particular methods and systems described herein may apply to both locally defined entities as well as entities in general.

Often when a user reads a document 165 they may encounter a locally defined entity such a character that they either are not familiar with or have otherwise forgotten. Because the character is not significant, or the document 165 is not popular, the user may be unable to determine more information about the character from an external source such as the Internet. Accordingly, the user may want to search for such information about the entity from one or more passages of the document.

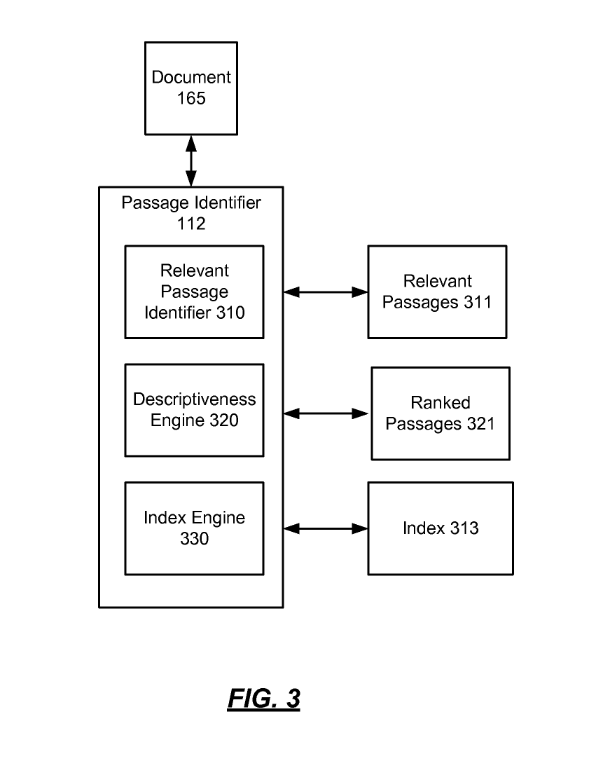

To facilitate such searches, the client device 110 may further include a passage identifier 112. The passage identifier 112 may receive an indicator of an entity, and may search the document 165 for passages that reference the indicated entity. As described further with respect to FIG. 3, the passage identifier 112 may identify passages that include the entity name, include possible variations on the entity name, as well as include pronouns or anaphors that likely refer to the entity. These identified passages may also be assigned a score that is based on how many times the entity (or variations or anaphors associated with the entity) appear in the passages, as well as other features such as the length of each passage.

The passage identifier 112 may determine which of the identified passages are likely to be the most descriptive of the indicated entity, and therefore the most helpful for the user to understand the indicated entity. As described further below, the descriptiveness of the identified passages may be determined based in part on the assigned score and by applying heuristics or rules based on observations about characteristics associated with descriptive passages.

The passage identifier 112 may present the most descriptive passages from the document to the user. The user may read one or more of the passages, and hopefully gain an understanding of the entity.

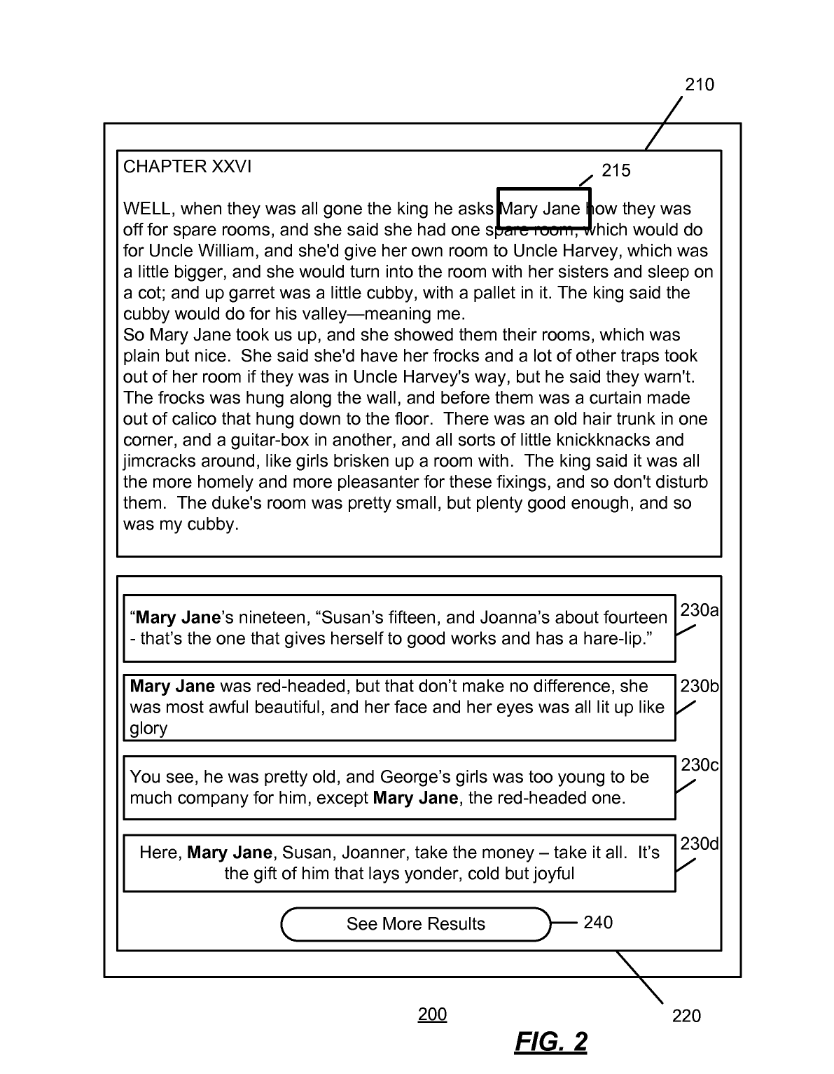

For example, FIG. 2 illustrates an example user interface 200. The user interface 200 may be implemented by a client device 110 such as an e-reader. A document 165 being read by a user is shown in a window 210 of the user interface 200. In the example shown, the document 165 is “Huckleberry Finn”. While reading the document 165, the user has encountered the entity “Mary Jane” that the user is unfamiliar with. Accordingly, the user has selected the entity name “Mary Jane”, using a touch-enabled display associated with the client device 110, or other input device, and a box 215 has been defined in the window 210 to indicate the selection.

In response to the selection, the passage identifier 112 has identified the most descriptive passages in the document 165 with respect to the entity “Mary Jane”. As shown, the passages 230a, 230b, 230c, and 230d have been identified and are displayed in a window 220 of the user interface 200. The selected entity name is shown bolded or otherwise highlighted or indicated in each of the identified passages.

In an implementation, if the user would like to view an identified passage in the document 165, the user may select one of the passages in the window 220, and the corresponding page or section of the document 165 that includes the selected passage may be displayed in the window 210. If the user is not satisfied with the presented passages 230a-230d, the user may activate the button 240 labeled “See More Results” and the next most descriptive passages may be displayed.

FIG. 3 is an illustration of an example passage identifier 112. As shown, the passage identifier 112 may comprise several components such as a relevant passage identifier 310, a descriptiveness engine 320, and an index engine 330. More or fewer components may be supported by the passage identifier 112.

The relevant passage identifier 310 may receive an identifier of an entity and may identify one or more passages in a document 165 that are relevant to the identified entity. The identified passages may be stored as the relevant passages 311. In some implementations, the relevant passage identifier 310 may identify relevant passages by calculating or otherwise determining what is referred to herein as an entity frequency for each passage in the document 165. The entity frequency may be an estimate of the number of times that the entity is referenced or mentioned in a passage and may include anaphoric references to the entity, and alternate versions of the entity (e.g., nicknames or aliases). Depending on the implementation, a passage may be determined to be a relevant passage by the relevant passage identifier 310 if its calculated entity frequency is greater than a threshold.

To determine the entity frequency of a passage p the relevant passage identifier 310 may identify entities e₁ . . . eₙ in the passage that match the name of the entity e being considered. The entities e₁ . . . eₙ may be matched using bag-of-words type matching, for example; however, other known methods for matching may be used.

Once the matching entities e₁ . . . eₙ are determined, the relevant passage identifier 310 may calculate an entity frequency EF(e,p) for the passage p with respect to the entity e using Equation (1), where CR(eᵢ) is a count of the number of anaphoric references in the passage that refer to eᵢ, rε[0, 1] controls the relative importance of the anaphoric reference as compared to eᵢ itself, and E(eᵢ,e) is the probability that an entity eᵢ is referring to the entity e:

EF(e,p)=Σᵢ₌₁^{N}E(eᵢ,e)·(1+r·CR(eᵢ)) (1).

If an entity eᵢ is the same as the entity e, then E(eᵢ,e) may be set to 1 by the relevant passage identifier 310. If an entity eᵢ has a different type than the entity e (e.g., e is a person and eᵢ is a location), then E(eᵢ,e) may be set to 0 by the relevant passage identifier 310. If eᵢ is a substring of e, and eᵢ is two or more words, then E(eᵢ,e) may be set to 1 by the relevant passage identifier 310. If e is a substring of eᵢ, and e is two or more words, then E(eᵢ,e) may be set to 1 by the relevant passage identifier 310. If neither eᵢ nor e are substrings of one another, then E(eᵢ,e) may be set to 0 by the relevant passage identifier 310. Otherwise, in an implementation, the relevant passage identifier 310 may determine E(eᵢ, e) using co-reference resolution.

Depending on the implementation, the relevant passage identifier 310 may perform co-reference resolution using one or more of a local co-reference heuristic or a global co-reference heuristic. For the local co-reference heuristic, for an entity eᵢ, the relevant passage identifier 310 may determine the entity, with a name that is a super string of eᵢ, that is the nearest entity in a passage before the current passage with a fixed window of preceding passages of the document 165. The window may be ten passages, for example. If the determined entity is the same as the entity e, then E(eᵢ,e) may be set to 1 by the relevant passage identifier 310.

For the global co-reference heuristic, for an entity eᵢ, the relevant passage identifier 310 may determine how often the entity eᵢ and the entity e appear together in passages outside of the window used in the local co-reference heuristic. The value of E(eᵢ, e) may be determined based on the number of times that the entities appear together. Depending on the implementation, the relevant passage identifier 310 may apply both the global and the local co-reference heuristics, or may apply the global-co-reference heuristic only when the local co-reference heuristic is unsuccessful.

As may be appreciated, the longer a passage is, the more likely that it includes content that may aid a user in understanding an entity. Similarly, there may be a minimum passage length where passages that are less than the minimum passage length are unlikely to provide much understanding of the entity regardless of the entity frequency of the passage. The minimum passage length may be determined through experimentation, for example. Accordingly, when determining the relevant passages 311, the relevant passage identifier 310, in addition to entity frequency, may further consider the length of the passages.

In some implementations, the relevant passage identifier 310 may combine passage length with entity frequency using Equation (2), where LRM(e, p) is the relevance score of a passage p with respect to an entity e, k₁ is a tunable parameter that controls the relationship between entity frequency and passage length, D is the length of the passage p, and D₀ is the minimum passage length:

$$LRM ( e , p ) = \frac{( {k}_{1} + 1 ) \cdot E ( e , p )}{{k}_{1} + E ( e , p )} \cdot log \vert D \vert / \vert {D}_{0} \vert . \qquad ( 2 )$$

The relevant passage identifier 310 may determine a relevance score for each passage in the document 165 using Equation (2). Depending on the implementation, passages with relevance scores that are greater than a threshold relevance score may be added to the relevant passages 311 and may be provided to the descriptiveness engine 320 along with their determined relevance scores. Alternatively, all passages and determined relevance scores may be provided to the descriptiveness engine 320 as the relevant passages 311.

The descriptiveness engine 320 may determine a descriptiveness score for each passage identified in the relevant passages 311 based on one or more descriptiveness signals which are described further below. The descriptiveness engine 320 may combine the descriptiveness signals with the determined relevance scores to determine descriptiveness scores for the relevant passages 311.

The descriptiveness signals may be based on one or more features of a passage that may indicate whether or not that passage is descriptive of the entity. One example of such descriptiveness signals are referred to herein as entity-centric descriptiveness signals. Entity-centric descriptiveness signals may include key words or phrases that tend to be associated with introducing or describing an entity. For example, for entities that are people, the entity-centric descriptiveness signals may include words or phrases that are often associated with bibliographic information, social status, career, experience, and family and social relationships. The entity-centric signals may include a count of the number of such words and phrases found in a passage.

In some implementations, the particular words or phrases are determined by observing known descriptive passages and determining the words that tend to occur in such passages with a high frequency. The words or phrases having the highest frequency may be selected for the entity-centric descriptiveness signals. For example, character description passages on Wikipedia, or another source, may be mined by the descriptiveness engine 320 to determine words that appear in the passages with a higher frequency than in the other passages.

As may be appreciated, the particular entity-centric features may be dependent on the type of entity being considered. For example, different descriptive words or phrases may be used for an entity that is a company than an entity that is a person. Therefore, the particular entity-centric descriptiveness signals that are considered by the descriptiveness engine 320 may be selected based on the type of entity being considered.

Another example of such descriptiveness signals are referred to herein as relational descriptiveness signals. Relational descriptiveness signals may include related entity signals and related action signals. The related entity signals may be based on the idea that entities are often described through their relationships with other entities. Thus, the more unique entities that are described in a passage, the more likely that the passage is descriptive. In some implementations, the related entity signals may include entities related to categories such as people, places, and times, and may include a count of the total number of entities of each type found in a passage. In addition, if the appearance of an entity in a passage is the first appearance of the entity in the document 165, then the passage may be descriptive. Accordingly, such signals may be weighted higher than other signals by the descriptiveness engine 320.

The related action signals may be based on the idea that when entities perform actions on one another, the rarer or more unusual actions are typically more informative than more frequent actions. Thus, for example, the phrases “A killed B”, or “A was born in B” are more informative than “A talked to B”, or “A went to B.”

In some implementations, the descriptiveness engine 320 may determine the inverse document frequency of a verb corresponding to the related action in the document 165. The determined inverse document frequency of the verb may be compared to the average, maximum, and minimum inverse document frequency of verbs associated with the entity to determine how rare or unusual the verb is. The average, maximum, and minimum inverse document frequency for each verb may be used as related action signals by the descriptiveness engine 320.

Another example of such descriptiveness signals are referred to herein as positional descriptiveness signals. The positional descriptive signals capture how the passages that are located in the beginning of a document 165 are often more descriptive than the passages that are located at the end of a document 165. For example, in a novel, characters are often introduced and described in the beginning of a novel. Positional descriptive signals may further capture how the earlier that an entity is introduced in a passage, the more likely that the passage is descriptive of that entity. For example, in a paragraph that is describing a character, the name of the character is likely to first appear in the first sentence of the paragraph rather than in the last sentence of the paragraph.

In some implementations, the descriptiveness engine 320 may use machine learning to train a classifier using a training set of known descriptive and known non-descriptive passages for a plurality of entities, along with computed relevance scores and the various descriptiveness signals determined for the passages. The trained classifier may be used by the descriptiveness engine 320 to determine the descriptiveness score for a passage using the descriptiveness signals determined for a passage and the relevance score computed for the passage.

The descriptiveness engine 320 may rank the relevant passages 311 according to the descriptiveness score determined for each of the relevant passages 311 by the classifier. The ranked relevant passages may be provided as the ranked passages 321. The ranked passages may be displayed in the window 220 of the user interface 200, for example. Depending on the implementation, the ranked passages 321 may include all of the relevant passages 311 in ranked order, or may include a subset of the passages with the highest determined descriptiveness scores. For example, only the five highest ranked passages may be provided for display.

The passage identifier 112 may further include an index engine 330. The index engine 330 may be used to generate an index 313 for a document 165 using the ranked passages 321. In some implementation, the index 313 may include an entry for each entity, or a subset of the entities, of the document 165, and a reference to one or more of the ranked passages 321 for the entity. For example, the index 313 may include an entry for each character of the document 165 and a page number of the document 165 where each of the ranked passages corresponding to that character is located in the document 165.

The index engine 330 may generate the index 313 by determining some or all of the entities in the document 165. Depending on the implementation, the index engine 330 may only consider entities that are for a particular class of entities such as people or places. In addition, only entities that occur in the document 165 more than a threshold number of times may be considered to avoid populating the index with entries for entities that are not significant to the document 165.

After determining the entities in the document 165, the index engine 330 may use the relevant passage identifier 310 and the descriptiveness engine 320 to generate the ranked passages 321 associated with each of the entities. The index engine 330 may then generate an index 313 for the document 165 by creating an entry for each entity and including a reference to the ranked passage 321 associated with the each of the entities.

Depending on the implementation, the index engine 330 may generate an index 313 for each document 165 and may associate the generated index 313 with the document 165. A user associated with the client device 110 may reference the index 313 associated with a document 165 when looking for information on a particular entity of the document 165. Alternatively or additionally, the passage identifier 112 may use the index 313 to recommend descriptive passages to the user for a selected entity when requested by the user.

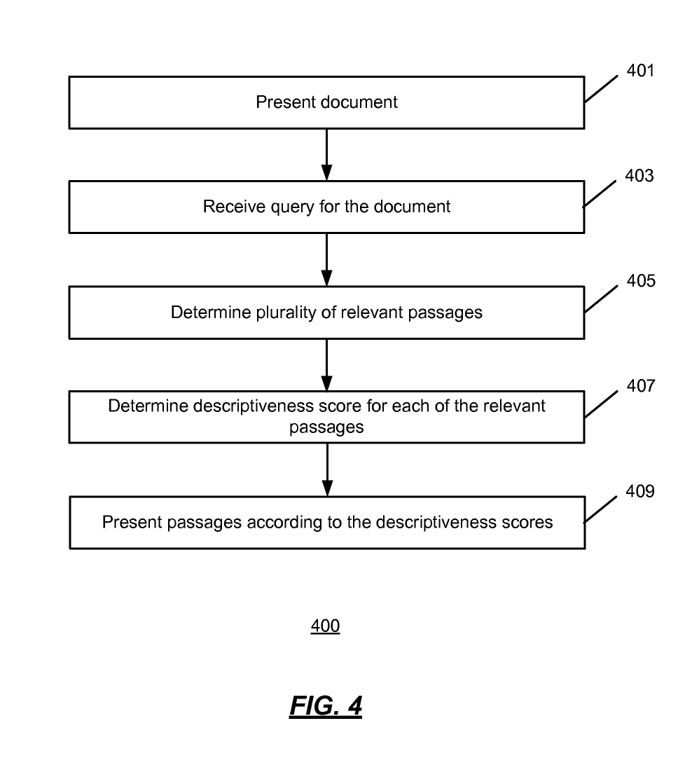

FIG. 4 is an operational flow of an implementation of a method 400 for determining and presenting descriptive passages. The method 400 may be implemented by the document viewer 111 and the passage identifier 112.

A document is presented at 401. The document 165 may be presented by the document viewer 111 of the client device 110. The document may include a plurality of passages and each passage may be a paragraph. For example, the document 165 may be an e-book, and the client device 110 may be an e-reader. The document 165 may be presented in the window 210 of the user interface 200, for example.

A query is received for the document at 403. The query may be received by the passage identifier 112 of the client device 110. The query may identify an entity. The entity may be one or more words that may correspond to a person or thing from the document 165. Depending on the implementation, the query may be generated by the user selecting the word or words corresponding to the entity in the document 165 displayed in the window 210.

A plurality of relevant passages is determined at 405. The relevant passages 311 may be determined by the relevant passage identifier 310 of the passage identifier 112. Depending on the implementations, the relevant passages 311 may be determined by computing an entity frequency for each passage of the document 165 with respect to the entity identified by the query. The entity frequency may be calculated by the relevant passage identifier 310 for each passage according to Equation (1).

Alternatively, the relevant passage identifier 310 may further calculate a relevance score for each passage using the calculated entity frequency for the passage and a length of the passage (e.g., number of words or characters in the passage). The relevance score may be calculated by the relevant passage identifier 310 using Equation (2), for example.

The relevant passage identifier 310 may determine the relevant passages 311 using the calculated entity frequencies and/or or relevance scores for each passage. In an implementation for example, the relevant passages 311 may by a percentage of the passages with the highest scores, or all passages with scores that are greater than a threshold.

A descriptiveness score is determined for each of the relevant passages at 407. The descriptiveness scores may be determined for the relevant passages 311 by the descriptiveness engine 320. Depending on the implementation, the descriptiveness engine 320 may compute a descriptiveness score for a passage based on the relevance score and/or entity frequency associated with the passage, and by using one or more of entity-centric descriptiveness signals, relational descriptiveness signals, and positional descriptiveness signals associated with the passage. The relevant passages may be ranked based on their descriptiveness scores and output as the ranked passages 321.

The passages are presented according to the descriptiveness scores at 409. The ranked passages 321 may be presented by the passage identifier 112 in the window 220 of the user interface 200. Depending on the implementation, the passages may be associated with the entity in an index, for example.

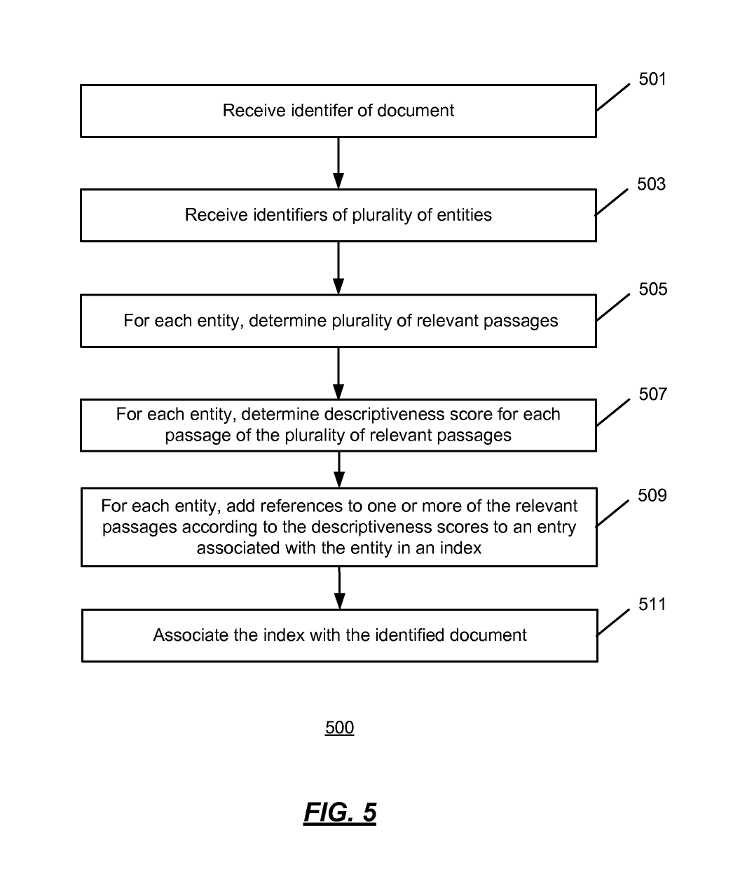

FIG. 5 is an operational flow of an implementation of a method 500 for generating an index for a document. The method 500 may be implemented by the index engine 330 of the passage identifier 112.

An identifier of a document is received at 501. The identifier may be received by the index engine 330. The document may include a plurality of passages, and each passage may include one or more entities.

For each entity, a plurality of relevant passages is identified at 505. The relevant passages 311 may be identified by the relevant passage identifier 310 by calculating a relevance score for each passage. The passages with relevance scores greater than a threshold score may be selected as the relevant passages 311.

For each entity, a descriptiveness score is determined for each passage of the plurality of relevant passages at 507. The descriptiveness score for a passage may be determined by the descriptiveness engine 320 using the relevance score calculated for the passage and one or more of entity-centric descriptiveness signals, relational descriptiveness signals, and positional descriptiveness signals associated with the passage.

For each entity, references to one or more of the relevant passages are added to an entry associated with the entity in an index according to the descriptiveness scores at 509. The references may be added to the entry in the index 313 by the index engine 330. The references may comprise links or indicators of the pages in the document 165 where each of the relevant passages may be found. Depending on the implementation, the index engine 330 may add references to a fixed number of relevant passages with the highest descriptiveness scores (e.g., top five, top ten, etc.), or may add references to all relevant passages with a descriptiveness score that is greater than a threshold.

The index is associated with the identified document at 511. The index 313 may be associated with the document 165 by the index engine 330. Depending on the implementation, the index may be stored at the client device 110, and may be used by the passage identifier 112 to identify descriptive passages in the document 165 for one or more of the entities with entries in the index 313. In addition, the index 313 may be provided to the document provider 160 for distribution to other client devices 110 that may request the associated document 165.

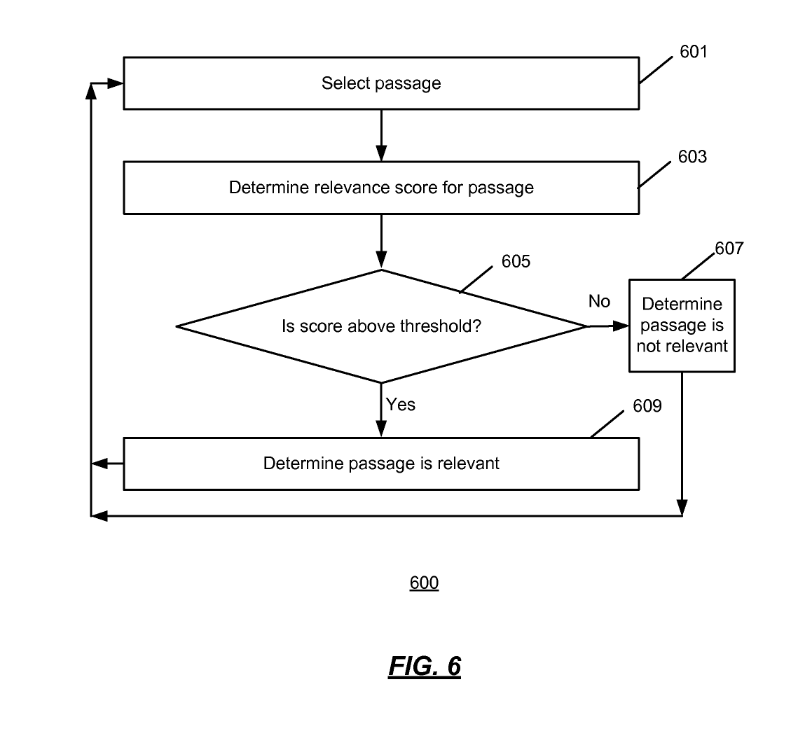

FIG. 6 is an operational flow of an implementation of a method 600 for determining relevant passages for an entity. The method 600 may be implemented by the relevant passage identifier 310 of the passage identifier 112.

A passage is selected at 601. The passage may be a passage from a document 165 and may be selected by the relevant passage identifier 310. The passage may be a paragraph. Other sized passages may be considered, such as a number of words, sentences, pages, and chapters, for example.

A relevance score is determined for the passage at 603. The relevance score for the passage may be determined by the relevant passage identifier 310. Depending on the implementation, the relevance score may be determined based on a length of the passage, and a calculated entity frequency for the passage. The entity frequency for a passage may be based on a number of times that the name of the entity appears in the passage. The entity frequency may also be based on aliases or variations of the entity name, along with anaphors or other references to the entity in the passage. The entity frequency and relevance score for a passage may be calculated using Equations (1) and (2), for example.

A determination is made as to whether the determined relevance score is above a threshold at 605. The determination may be made by the relevant passage identifier 310. If the relevance score is not above the threshold, then the method 600 may continue at 607. Otherwise, the method 600 may continue at 609.

That the passage is not relevant is determined at 607. Because the relevance score is below the threshold, it may not be considered further by the relevant passage identifier 310. The method 600 may then return to 601 where a next passage in the document 165 may be considered.

That the passage is relevant is determined at 609. Because the relevance score is above the threshold, it may be added to the set of relevant passages 311 by the relevant passage identifier 310. The method 600 may then return to 601 where a next passage in the document 165 may be considered.

FIG. 7 shows an exemplary computing environment in which example implementations and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 7, an exemplary system for implementing aspects described herein includes a computing device, such as computing device 700. In its most basic configuration, computing device 700 typically includes at least one processing unit 702 and memory 704. Depending on the exact configuration and type of computing device, memory 704 may be volatile (such as random access memory (RAM)), non-volatile (such as read-only memory (ROM), flash memory, etc.), or some combination of the two. This most basic configuration is illustrated in FIG. 7 by dashed line 706.

Computing device 700 may have additional features/functionality. For example, computing device 700 may include additional storage (removable and/or non-removable) including, but not limited to, magnetic or optical disks or tape. Such additional storage is illustrated in FIG. 7 by removable storage 708 and non-removable storage 710.

Computing device 700 typically includes a variety of computer readable media. Computer readable media can be any available media that can be accessed by device 700 and include both volatile and non-volatile media, and removable and non-removable media.

Computer storage media include volatile and non-volatile, and removable and non-removable media implemented in any method or technology for storage of information such as computer readable instructions, data structures, program modules or other data. Memory 704, removable storage 708, and non-removable storage 710 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media may be part of computing device 700.

Computing device 700 may contain communication connection(s) 712 that allow the device to communicate with other devices. Computing device 700 may also have input device(s) 714 such as a keyboard, mouse, pen, voice input device, touch input device, etc. Output device(s) 716 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
determining a plurality of relevant passages of a plurality of passages of a document by a computing device, wherein each relevant passage is relevant to a locally defined entity;
determining a descriptiveness score for each of the relevant passages with respect to the locally defined entity by the computing device; and
associating one or more of the relevant passages with the locally defined entity according to the determined descriptiveness scores by the computing device.

2. The method of claim 1, further comprising receiving a query, wherein the query identifies the locally defined entity.

3. The method of claim 2, wherein the query is received in response to a selection of the identified locally defined entity in the document.

4. The method of claim 1, further comprising presenting one or more of the relevant passages according to the determined descriptiveness scores.

5. The method of claim 4, wherein presenting one or more of the determined passages according to the determined descriptiveness score comprises presenting the determined passages on a display of the computing device along with the document.

6. The method of claim 1, wherein a passage comprises one or more of a paragraph, a sentence, or a chapter of the document.

7. The method of claim 1, wherein determining a plurality of relevant passages of the plurality of passages of the document comprises:
for each passage of the plurality of passages:
determining a relevance score for the passage;
determining that the determined relevance score is greater than a threshold; and
determining that the passage is a relevant passage in response to determining that the determined relevance score is greater than the threshold.

8. The method of claim 7, wherein determining the relevance score for the passage comprises:
determining an entity frequency for the passage with respect to the identified locally defined entity;
determining a length of the passage; and
determining the relevance score based on the entity frequency and the determined length.

9. The method of claim 8, wherein determining the entity frequency for the passage comprises determining a number of entities in the passage that are co-references of the identified locally defined entity, and determining the entity frequency based on the determined number of entities in the passage that are co-references of the identified locally defined entity.

10. The method of claim 1, wherein determining the descriptiveness score for a relevant passage comprises determining the descriptiveness score based on one or more of an entity-centric descriptiveness signal, a relational descriptiveness signal, and a positional descriptiveness signal for the relevant passage.

11. The method of claim 1, wherein the document is a story, and the locally defined entity is a character in the story.

12. The method of claim 1, wherein associating one or more of the relevant passages with the locally defined entity comprises adding references to one or more of the relevant passages to an entry associated with the locally defined entity in an index according to the determined descriptiveness score.

13. A method comprising:
receiving an identifier of a document by a computing device, wherein the document comprises a plurality of passages;
receiving identifiers of a plurality of entities by the computing device;
for each identified entity:
determining a plurality of relevant passages of the plurality of passages of the document by the computing device, wherein each relevant passage is relevant to the identified entity;
determining a descriptiveness score for each of the relevant passages with respect to the identified entity by the computing device; and
adding references to one or more of the relevant passages to an entry associated with the identified entity in an index according to the determined descriptiveness score by the computing device; and
associating the index with the identified document by the computing device.

14. The method of claim 13, wherein a passage comprises one or more of a paragraph, a sentence, or a chapter.

15. The method of claim 13, wherein determining a plurality of relevant passages of the plurality of passages of the document comprises:
for each passage of the plurality of passages:
determining a relevance score for the passage;
determining that the determined relevance score is greater than a threshold; and
determining that the passage is a relevant passage in response to determining that the determined relevance score is greater than the threshold.

16. The method of claim 15, wherein determining a relevance score for the passage comprises:
determining an entity frequency for the passage with respect to the identified entity;
determining a length of the passage; and
determining the relevance score based on the entity frequency and the determined length.

17. A system comprising:
at least one computing device; and
a document viewer adapted to present a document on a display of the at least one computing device, wherein the document comprises a plurality of passages and each passage comprises one or more entities; and
a passage identifier adapted to:
receive an identifier of an entity presented by the document viewer;
determine a relevance score for each passage of the plurality of passages based on an entity frequency of the identified entity in the passage and a length of the passage;
determine a descriptiveness score for each passage of the plurality of passages using the relevance score of the passage and one or more signals from the passage; and
present one or more of passages of the plurality of passages according to the determined descriptiveness score on the display of the at least one computing device.

18. The system of claim 17, wherein the at least one computing device is one or more of an e-reader, a smart phone, a laptop, or a tablet computer.

19. The system of claim 17, wherein a passage comprises one or more of a paragraph, a sentence, or a chapter.

20. The system of claim 17, wherein the one or more signals comprise one or more of an entity-centric descriptiveness signal, a relational descriptiveness signal, and a positional descriptiveness signal.
